(19) United States
(12) Patent Application Publication
(10) Pub. No.: US 2023/0199670 A1
(43) Pub. Date: Jun. 22, 2023

(54) Pathloss Reference Signal Management

(71) Applicant: Apple Inc., Cupertino, CA (US)

(72) Inventors: Yushu ZHANG, Beijing (CN); Dawei ZHANG, Saratoga, CA (US); Haitong SUN, Cupertino, CA (US); Hong HE, San Jose, CA (US); Jie CUI, San Jose, CA (US); Wei ZENG, Saratoga, CA (US); Weidong YANG, San Diego, CA (US); Yang TANG, San Jose, CA (US)

(21) Appl. No.: 17/995,454

(22) PCT Filed: Apr. 8, 2020
(86) PCT No.: PCT/CN2020/083805

§ 371 Date: Oct. 4, 2022

(51) Int. Cl. H04W 52/24; H04W 52/14; H04W 52/16

(52) U.S. Cl. CPC H04W 52/242; H04W 52/146; H04W 52/16

(57) ABSTRACT

The exemplary embodiments relate to user equipment (UE) monitoring one or more downlink reference signals for uplink power control. The UE may receive an indication that a downlink reference signal is assigned to the UE for a first operation. The first operation is uplink power control for an uplink signal. The UE then determines whether the UE is configured to monitor the downlink reference signal for a second different operation. When the UE is configured to monitor the downlink reference signal for the second different operation, the UE configures the downlink reference signal to be a pathloss reference signal that is to be used for the first operation.

### BACKGROUND

A user equipment (UE) may be configured to monitor one or more downlink reference signals for uplink power control. For example, the UE may determine the transmission power for a particular uplink channel or signal based, at least in part, on a pathloss metric derived from a downlink reference signal. Different downlink reference signals may be used for different uplink channels or signals. Accordingly, there is a need for a mechanism that manages the downlink reference signals the UE is configured to monitor for uplink power control.

### SUMMARY

According to an exemplary embodiment a method is performed at a user equipment (UE). The method includes receiving an indication that a downlink reference signal is assigned to the UE for a first operation. The first operation is uplink power control for an uplink signal. The UE then determines whether the UE is configured to monitor the downlink reference signal for a second different operation. When the UE is configured to monitor the downlink reference signal for the second different operation, the UE configures the downlink reference signal to be a pathloss reference signal that is to be used for the first operation.

Further exemplary embodiments include a transceiver configured to communicate with a network and a processor configured to perform operations. The operations include receiving an indication that a downlink reference signal is assigned to the UE for a first operation. The first operation is uplink power control for an uplink signal. The UE then determines whether the UE is configured to monitor the downlink reference signal for a second different operation. When the UE is configured to monitor the downlink reference signal for the second different operation, the UE configures the downlink reference signal to be a pathloss reference signal that is to be used for the first operation.

Still further exemplary embodiments include an integrated circuit. The integrated circuit include circuitry configured to receive an indication that a downlink reference signal is assigned to a UE for a first operation. The first operation is uplink power control for an uplink signal. The integrated circuit then determines whether the UE is configured to monitor the downlink reference signal for a second different operation and selects the downlink reference signal as a pathloss reference signal that is to be used for the first operation when the UE is configured to monitor the downlink reference signal for the second different operation.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary method for pathloss reference signal management according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) monitoring one or more downlink reference signals for uplink power control.

The exemplary embodiments are described with regard to a pathloss reference signal. Throughout this description, the term “pathloss reference signal” refers to a downlink reference signal that may be utilized by the UE for uplink power control. For example, the UE may determine the transmission power for a particular uplink channel or signal based, at least in part, on a pathloss metric derived from a pathloss reference signal. Different pathloss reference signals may be used for different uplink channels or signals. Thus, the UE may be configured to monitor multiple pathloss reference signals at the same time. However, use of the term pathloss reference signal is merely provided for illustrative purposes, different entities may refer to a similar concept by a different name.

The exemplary embodiments are also described with regard to an active reference signal. Throughout this description when a reference signal is characterized as active, the UE is configured to monitor that reference signal. Thus, the UE may know the frequency and time that the network is to transmit an active reference signal. From the perspective of the UE, activating a reference signal may include operations such as, but not limited to, receiving control information from the network associated with the reference signal, collecting one or more samples of the reference signal and processing the samples. However, reference to an active reference signal is merely provide for illustrative purposes, different entities may refer to a similar concept by a different name.

The exemplary embodiments are further described with regard to the UE determining which reference signals are to be utilized as pathloss reference signals for a particular channel or signal. In a first aspect, this may include the UE activating a reference signal, e.g., monitoring the reference signal. In a second aspect, this may include the UE determining that a reference signal that is active for a different purpose may also be used as a pathloss reference signal for uplink power control. The exemplary embodiments include various techniques that may be implemented by the UE to configure an already active reference signal as a pathloss reference signal for a particular uplink channel or signal.

The exact manner of using one or more pathloss reference signals for uplink power control is beyond the scope of the exemplary embodiments. Instead, the exemplary embodiments are directed towards how the UE determines that a reference signal is to be used as a pathloss reference signal. The exemplary techniques described herein may be used with currently implemented reference signal management techniques, future implementations of reference signal management techniques or independently from other reference signal management techniques.

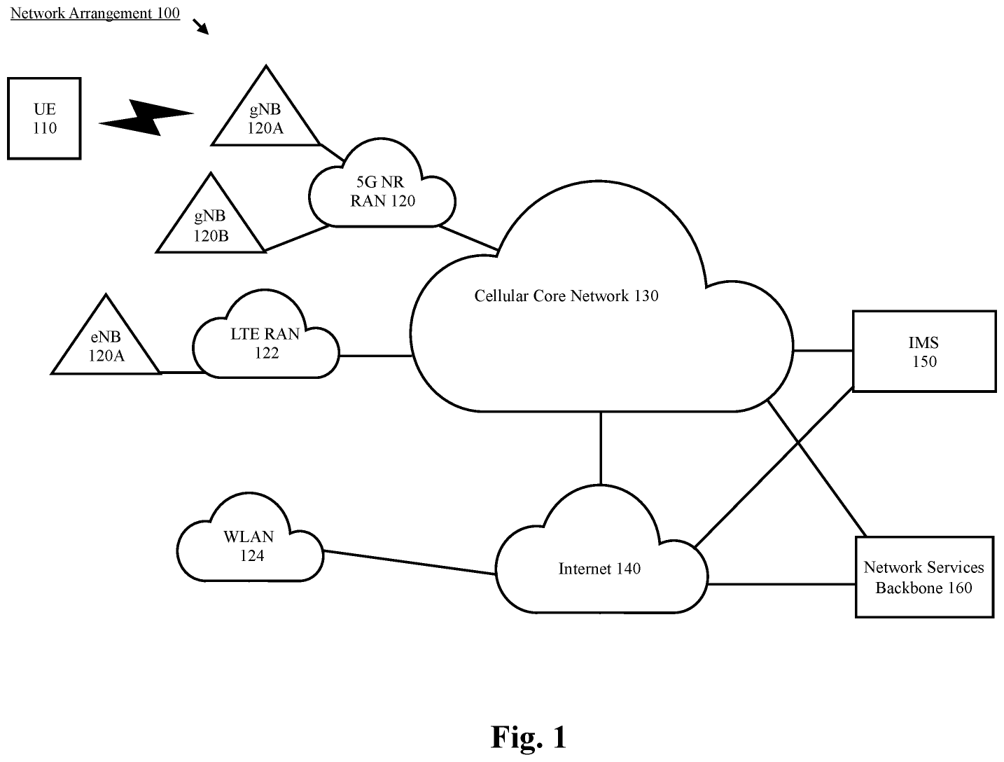

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are a 5G New Radio (NR) radio access network (5G NR-RAN) 120, an LTE radio access network (LTE-RAN) 122 and a wireless local access network (WLAN) 124. However, it should be understood that the UE 110 may also communicate with other types of networks and the UE 110 may also communicate with networks over a wired connection. Therefore, the UE 110 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, Sprint, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via the gNB 120A. The gNB 120A may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. During operation, the UE 110 may be within range of a plurality of gNBs. Thus, either simultaneously or alternatively, the UE 110 may also connect to the 5G NR-RAN 120 via the gNB 120B. Reference to two gNBs 120A, 120B is merely for illustrative purposes. The exemplary embodiments may apply to any appropriate number of gNBs. Further, the UE 110 may communicate with the eNB 122A of the LTE-RAN 122 to transmit and receive control information used for downlink and/or uplink synchronization with respect to the 5G NR-RAN 120 connection.

Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., the gNB 120A of the 5G NR-RAN 120).

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

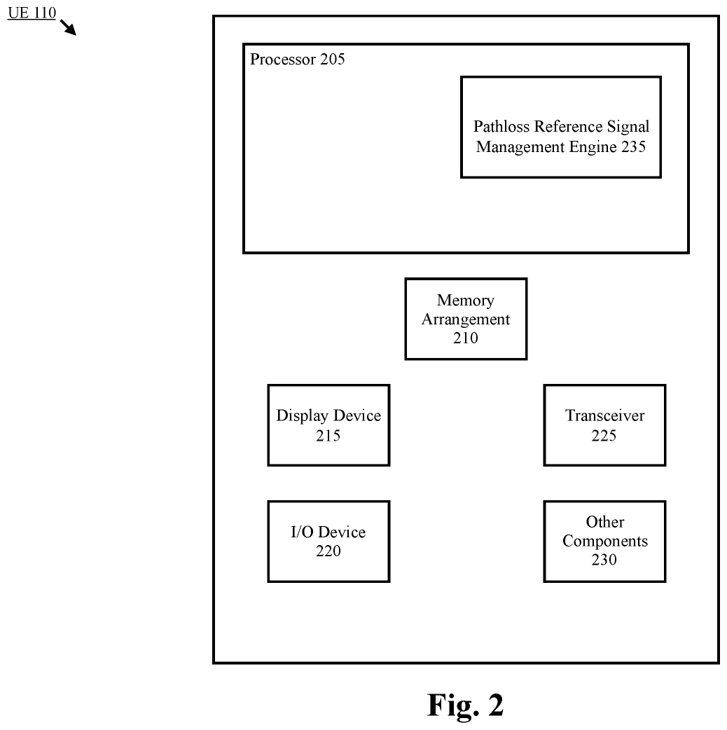

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225 and other components 230. The other components 230 may include, for example, an audio input device, an audio output device, a battery that provides a limited power supply, a data acquisition device, ports to electrically connect the UE 110 to other electronic devices, one or more antenna panels, etc.

The processor 205 may be configured to execute a plurality of engines of the UE 110. For example, the engines may include a pathloss reference signal management engine 235. The pathloss reference signal management engine 235 may perform various operations related to configuring a downlink reference signal as a pathloss reference signal for uplink power control for a particular uplink channel or signal. The pathloss reference signal management engine 235 may manage multiple pathloss reference signals for multiple uplink channels or signals.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122, the WLAN 124, etc. Accordingly, the transceiver 225 may operate on a variety of different frequencies or channels (e.g., set of consecutive frequencies).

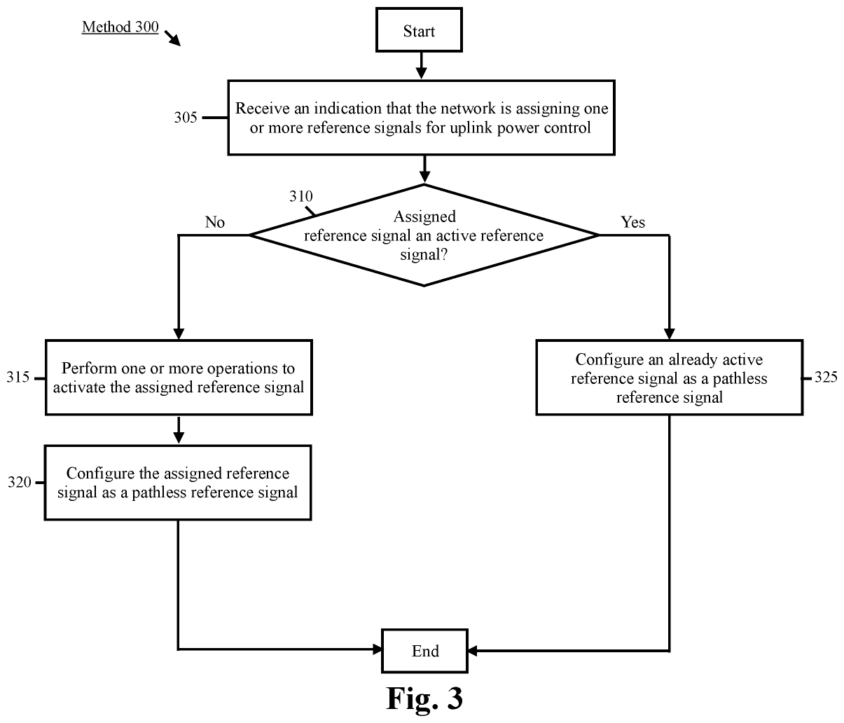

FIG. 3 shows an exemplary method 300 for pathloss reference signal management according to various exemplary embodiments. The method 300 will be described with regard to the UE 110 of FIG. 2 and the network arrangement 100 of FIG. 1.

In 305, the UE 110 receives an indication that the network is assigning one or more reference signals to the UE 110 that are to be used for uplink power control. For example, the UE 110 may receive control information such as, but not limited to, an identity of the assigned reference signals, an indication as to when the assigned reference signals are to be transmitted by the network and an indication that the assigned reference signals are to be used for uplink power control. The network may transmit the control information to the UE 110 using a medium access control (MAC) control element (CE), a radio resource control (RRC) message or any other appropriate type of higher layer signaling.

The above operation in 305 is described with regard to one or more reference signals that are assigned by the network. The following operations in 310-325 may then be performed on a per reference signal basis. As will be described in more detail below, this may include activating a reference signal indicated in 305 (e.g., 310-320) and determining that a reference signal indicated in 305 is already an active reference signal (e.g., 310 and 325).

In 310, the UE 110 determines whether an assigned reference signal is an active reference signal. As mentioned above, an active reference signal refers to a reference signal the UE 110 is configured to monitor. The UE 110 may be configured with multiple active reference signals at the same time. Thus, in some scenarios, the UE 110 may already be configured to monitor the assigned one or more reference signals for a different purpose. There are various factors that may provide the basis for the UE 110 to determine that an already active reference signal is to be used as a pathloss reference signal. Specific examples of how the UE 110 may determine whether the one or more assigned reference signals are active reference signals will be described in more detail below after the description of the method 300.

If an assigned reference signal is not an active reference signal, the method 300 continues to 315. In 315, the UE 110 performs one or more operations to activate the assigned reference signal. This may include operations such as, but not limited to, listening to the corresponding downlink channel, collecting one or more samples and processing the collected samples. For example, the UE 110 may collect layer 3 (L3) reference signal received power (RSRP) measurement data corresponding to the assigned reference signal using (Y) samples. The UE 110 may collect multiple samples to ensure that the UE 110 has an accurate understanding of the assigned reference signal prior to activating the assigned reference signal and using it for uplink power control.

In 320, the UE 110 configures the assigned reference signal as a pathloss reference signal. Subsequently, this pathloss reference signal may be used by the UE 110 for uplink power control for a particular uplink channel or signal.

Returning to 310, if an assigned reference signal is already an active reference signal, the method 300 continues to 325. In 325, the UE 110 configures an already active reference signal as a pathloss reference signal. Since the assigned reference signal was already an active reference signal, the UE 110 already knows the applicable timing of the assigned reference signal and has an accurate understanding of the assigned reference signal. Thus, the UE 110 does not need to perform the type of operations described above with regard to 315. This allows the UE 110 to minimize the delay associated with configuring the UE 110 with the pathloss reference signal. Subsequently, this pathloss reference signal may be used by the UE 110 for uplink power control for a particular uplink channel or signal.

As mentioned above with regard to 310 of the method 300, there are various factors that may provide the basis for the UE 110 configuring a pathloss reference signal. In a first aspect, this may be based on identifying a predetermined condition. In a second aspect, this may be based on higher layer signaling. In a third aspect, this may be based on a combination of one or more predetermined conditions and higher layer signaling. Each of these aspects will be described in more detail below.

There are various predetermined conditions that may indicate to the UE 110 that an assigned reference signal is already an active reference signal. One exemplary predetermined condition may relate to whether the assigned reference signal is configured as a pathloss reference signal for another uplink channel or signal. For example, during operation, the UE 110 may receive RRC signals and/or MAC CEs that trigger the UE 110 to configure (e.g., activate) a reference signal as a pathloss reference for a particular uplink channel or signal. If the UE 110 has already been configured with a reference signal assigned in 305 for uplink power control of a different uplink channel or signal, the assigned reference signal has already been activated.

Another exemplary predetermined condition may relate to whether the assigned reference signal is configured as a pathloss reference signal for power headroom (PHR) reporting. Those skilled in the art will understand that PHR relates to how much of the maximum transmission power the UE 110 has left to utilize. The UE 110 may be configured to periodically measure and report PHR metrics to the network. If the UE 110 has already been configured with a reference signal assigned in 305 for PHR reporting, the assigned reference signal has already been activated.

Another exemplary predetermined condition may relate to whether the assigned reference signal is configured as a default pathloss reference signal. For example, the network may indicate to the UE 110 that a particular reference signal is to be used as the pathloss reference signal if the network does not assign the UE 110 a pathloss reference signal for a particular uplink channel or signal. If the UE 110 has already been configured with a reference signal assigned in 305 because it is the default reference signal, the assigned reference signal has already been activated.

Another exemplary predetermined condition may relate to whether the assigned reference signal is configured as a reference signal to be used for layer 1 (L1) RSRP measurement or L3 RSRP measurement for a purpose other than uplink power control. For example, in accordance with procedures related to UE 110 mobility, the UE 110 may be configured to monitor various reference signals. However, the exemplary embodiments are not limited to mobility procedures and may apply to reference signals used for any appropriate purpose. If the UE 110 has already been configured with a reference signal assigned in 305 for a different purpose, the assigned reference signal has already been activated.

In some embodiments, the UE 110 may be limited to monitoring a maximum number of pathloss reference signals (N) for a bandwidth part (BWP) or a serving cell. However, there may be a scenario where the UE 110 is assigned more than N reference signals and more than N active reference signals are available to be selected as pathloss reference signals. In this type of scenario, the UE 110 may select N reference signals as pathloss reference signals from a group of more than N active reference signals. Alternatively, there may be a scenario where the UE 110 is assigned less than N reference signals. In this type of scenario, after the assigned reference signals are activated or selected from active reference signals, the UE 110 may select additional active reference signals until N pathloss reference signals are configured. In either scenario, the UE 110 may have to decide which active reference signals from a set of active reference signals should be used as pathloss reference signals for a particular uplink channel or signal.

To differentiate between active reference signals, the UE 110 may utilize the following exemplary criteria. Initially, the UE 110 may select active reference signals using one or more of the predetermined conditions mentioned above. In this example, the UE 110 may select active reference signals that satisfy the following predetermined conditions: i) pathloss reference signals for another uplink channel or signal, ii) pathloss reference signal for power headroom (PHR) reporting and iii) a default pathloss reference signal. However, the exemplary embodiments are not limited to these exemplary predetermined conditions and may utilize any appropriate predetermined condition when differentiating between active reference signals.

The total sum of active reference signals that satisfy the predetermined conditions may be represented by (N1). If N1<N, the UE 110 may select additional reference signals from the set of active reference signals to be pathloss reference signals for a particular uplink channel or signal. However, the UE 110 is not required to select any additional active reference signals or activate any additional reference signals. Instead, the UE 110 may decide that no additional pathloss reference signals are to be configured for a particular uplink channel or signal.

To further differentiate between the active reference signals the UE 110 may use the following exemplary criteria. One exemplary criterion may relate to the active reference signals with the lowest and/or the highest ID. Another exemplary criterion may relate to the active reference signals with the smallest and/or largest periodicity. A further exemplary criterion may relate to the active reference signals that provided the basis for the latest channel state information (CSI) report. The UE 110 may utilize the above mentioned criteria until N pathloss reference signals have been selected. Alternatively, the UE 110 may implement one or more of the above mentioned criteria and then determine that no additional pathloss reference signals are to be configured.

During operation, the UE 110 may be configured with carrier aggregation (CA) and/or enhanced dual connectivity (ENDC). Thus, the UE 110 may be configured with two or more component carriers (CCs). When using the predetermined conditions and/or criteria mentioned above, the UE 110 may decide that active pathloss reference signals relative to a first CC may be used for power control for uplink channels or signals in CCs other than the first CC. Thus, in some embodiments, when the UE 110 is determining which active reference signals for a particular uplink channel or signal on the first CC, the UE 110 may consider active reference signals from a different CC to be available for selection. Alternatively, the UE 110 may not consider active reference signals from a different CC. The UE 110 may decide whether or not active reference signals from a different CC are available for selection using any appropriate basis.

As mentioned above, in some embodiments, the UE 110 may configure a pathloss reference signal based on higher layer signaling. For example, the UE 110 may receive an RRC signal and/or a MAC CE that triggers the UE 110 to activate one or more reference signals for uplink power control for a particular uplink channel or signal.

Reference signal activation via higher layer signaling may be a layered process. For example, the network may initially indicate to the UE 110 that a first set of two or more reference signals are available to be used as pathloss reference signals. This indication may be provided to the UE 110 in an RRC message. The network may then subsequently indicate to the UE 110 that a second set of reference signals that is a subset of the first set of reference signals is to be activated for uplink power control for a particular uplink channel or signal. This indication may be provided to the UE 110 in a MAC CE. Thus, the network may send an RRC message to the UE 110 identifying possible pathloss reference signals and then send a MAC CE triggering the UE 110 to activate a subset of the possible pathloss reference signals. In some embodiments, the UE 110 may be permitted to configure cross CC or cross BWP pathloss reference signals. To facilitate this, the CC index and/or BWP index may be included in the higher layer signaling in addition to a pathloss reference signal index. Alternatively, the UE 110 may not be permitted to configure cross CC or cross BWP pathloss reference signals. Thus, only the pathloss reference signal index may be provided to the UE 110.

As mentioned above, in some embodiments, the UE 110 may configure a pathloss reference signal based on a combination of predetermined conditions and higher layer signaling. In this type of arrangement, the UE 110 may initially determine a first set of active reference signals based on one or more of the predetermined conditions mentioned above. For example, the UE 110 may identify active reference signals based on i) pathloss reference signals for another uplink channel or signal, ii) pathloss reference signal for power headroom (PHR) reporting, iii) default pathloss reference signals and iv) reference signals used for used for L1 RSRP measurement or L3 RSRP measurement for a purpose other than uplink power control (e.g., mobility, etc.).

Subsequently, the UE 110 may determine a second set of active reference signals based on higher layer signaling. For example, the UE 110 determine which reference signals have been activated via an RRC message and/or a MAC CE. If the total number of reference signals from the first set of active reference signals and the second set of active reference signals is less than or equal to the maximum number of pathloss reference signals (N), the UE 110 may utilize the total number of reference signals from the first set of active reference signals and the second set of active reference signals.

In some embodiments, if the total number of reference signals from the first set of active reference signals and the second set of active reference signals is greater than the maximum number of pathloss reference signals (N), the UE 110 may select active reference signals from only the first set of active reference signals. Alternatively, the UE 110 may select active reference signals from only the second set of active reference signals.

In other embodiments, if the total number of reference signals from the first set of active reference signals and the second set of active reference signals is greater than the maximum number of pathloss reference signals (N), the UE 110 may select active reference signals from second set of active reference signals based on the following criteria. One exemplary criterion may relate to the active reference signals with the lowest and/or the highest ID. Another exemplary criterion may relate to the active reference signals with the smallest and/or largest periodicity. A further exemplary criterion may relate to the active reference signals that provided the basis for the latest channel state information (CSI) report. The UE 110 may utilize the above mentioned criteria until N pathloss reference signals have been selected. Alternatively, the UE 110 may implement one or more of the above mentioned criteria and then determine that no additional pathloss reference signals are to be configured.

As indicated above in the description of the UE 110 in FIG. 2, the UE 110 may be equipped with other components 230 that include one or more antenna panels. In some embodiments, the status of an antenna panel may be considered when configuring a pathloss reference signal. For example, consider the predetermined condition mentioned above related to whether a reference signal is a pathloss reference signal for a different uplink channel or signal. This predetermined condition may further include whether the same antenna panel (e.g., panel ID) is configured for the target uplink channel or signal and different uplink channel or signal.

Further, consider the predetermined condition mentioned above related to whether a reference signal is a pathloss reference signal for PHR reporting. This predetermined condition may further include whether the same antenna panel (e.g., panel ID) is configured for the target uplink channel or signal and the PHR operations. Also, consider the predetermined condition mentioned above related to whether a reference signal is a default reference signal. This predetermined condition may further include whether the same antenna panel (e.g., panel ID) is configured for the target uplink channel or signal and the uplink channel or signal based on the default reference signal. Still further, consider the predetermined condition mentioned above related reference signals used for used for L1 RSRP measurement or L3 RSRP measurement for a purpose other than uplink power control (e.g., mobility, etc.). This predetermined condition may further include whether the same antenna panel is configured for the for the target uplink channel or signal and the L1/L3 measurement.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
at a user equipment (UE):
receiving an indication that a downlink reference signal is assigned to the UE for a first operation, wherein the first operation is uplink power control for an uplink signal;
determining whether the UE is configured to monitor the downlink reference signal for a second different operation; and
when the UE is configured to monitor the downlink reference signal for the second different operation, configuring the downlink reference signal to be a pathloss reference signal that is to be used for the first operation.

2. The method of claim 1, further comprising:
when the UE is not configured to monitor the downlink reference signal for the second different operations, activating the downlink reference signal, wherein activating the downlink reference signal includes collecting measurement data corresponding to the downlink reference signal; and
configuring the downlink reference signal to be a pathloss reference signal that is to be for the first operation after activating the downlink reference signal.

3. The method of claim 1, wherein determining whether the UE is configured to monitor the downlink reference signal for a second different operation includes identifying that the downlink reference signal is configured as one of i) a pathloss reference signal for the second different operation, ii) a reference signal for power headroom (PHR) reporting, iii) a default pathloss reference signal or iv) a reference signal to be used for a UE mobility procedure.

4. The method of claim 1, wherein determining whether the UE is configured to monitor the downlink reference signal for a second different operation is based on higher layer signaling.

5. The method of claim 4, wherein the higher layer signaling includes at least one of a radio resource control (RRC) message of a medium access control (MAC) control element (CE).

6. The method of claim 1, wherein configuring the downlink reference signal to be a pathloss reference signal is further based on one of i) an ID, ii) periodicity or iii) inclusion in a channel state information (CSI) report.

7. The method of claim 1, wherein the downlink reference signal corresponds to a component carrier (CC) that is different than a CC corresponding to the uplink signal.

8. The method of claim 1, wherein configuring the downlink reference signal to be a pathloss reference signal is further based on an antenna panel that is to be used for the uplink signal.

9. A user equipment (UE), comprising:
a transceiver configured to communicate with a network; and
a processor configured to perform operations, the operations comprising:
receiving an indication that a downlink reference signal is assigned to the UE for a first operation, wherein the first operation is uplink power control for an uplink signal;
determining whether the UE is configured to monitor the downlink reference signal for a second different operation; and
when the UE is configured to monitor the downlink reference signal for the second different operation, configuring the downlink reference signal to be a pathloss reference signal that is to be used for the first operation.

10. The UE of claim 9, the operations further comprising:
when the UE is not configured to monitor the downlink reference signal for the second different operations, activating the downlink reference signal, wherein activating the downlink reference signal includes collecting measurement data corresponding to the downlink reference signal; and
configuring the downlink reference signal to be a pathloss reference signal that is to be for the first operation after activating the downlink reference signal.

11. The UE of claim 9, wherein determining whether the UE is configured to monitor the downlink reference signal for a second different operation includes identifying that the downlink reference signal is configured as one of i) a pathloss reference signal for the second different operation, ii) a reference signal for power headroom (PHR) reporting or iii) a default pathloss reference signal.

12. The UE of claim 11, wherein determining whether the UE is configured to monitor the downlink reference signal for a second different operation includes identifying that the downlink reference signal is configured as a reference signal to be used for a UE mobility procedure.

13. The UE of claim 9, wherein determining whether the UE is configured to monitor the downlink reference signal for a second different operation is based on higher layer signaling.

14. The UE of claim 13, wherein the higher layer signaling includes at least one of a radio resource control (RRC) message of a medium access control (MAC) control element (CE).

15. The UE of claim 9, wherein configuring the downlink reference signal to be a pathloss reference signal is further based on an antenna panel that is to be used for the uplink signal.

16. An integrated circuit, comprising:
circuitry configured to receive an indication that a downlink reference signal is assigned to a UE for a first operation, wherein the first operation is uplink power control for an uplink signal;
circuitry configured to determine whether the UE is configured to monitor the downlink reference signal for a second different operation; and
circuitry configured to select the downlink reference signal as a pathloss reference signal that is to be used for the first operation when the UE is configured to monitor the downlink reference signal for the second different operation.

17. The integrated circuit of claim 16, further comprising:
circuitry configured to activate the downlink reference signal when the UE is not configured to monitor the downlink reference signal for the second different operations, wherein activating the downlink reference signal includes collecting measurement data corresponding to the downlink reference signal; and
circuitry configured to select the downlink reference signal as a pathloss reference signal that is to be for the first operation after activating the downlink reference signal.

18. The integrated of claim 16, wherein determining whether the UE is configured to monitor the downlink reference signal for a second different operation includes identifying that the downlink reference signal is configured as one of i) a pathloss reference signal for the second different operation, ii) a reference signal for power headroom (PHR) reporting, iii) a default pathloss reference signal or iv) a reference signal to be used for a UE mobility procedure.

19. The integrated circuit of claim 16, wherein determining whether the UE is configured to monitor the downlink reference signal for a second different operation is based on higher layer signaling.

20. The integrated circuit of claim 16, wherein selecting the downlink reference signal to be a pathloss reference signal is further based on an antenna panel that is to be used for the uplink signal.
